(19) United States
(12) Patent Application Publication
(10) Pub. No.: US 2003/0148016 A1
(43) Pub. Date: Aug. 7, 2003

(54) Energy fitness water

(76) Inventor: Muhammad S. Choudhry, Algonquin, IL (US)

Correspondence Address: Muhammad S. Choudhry, 1420 - Brandywine Circle, Algonquin, IL, 60102, US

(21) Appl. No.: 10/067,636

(22) Filed: Feb. 7, 2002

(51) Int. Cl. A23G 3/00

(52) U.S. Cl. 426/660

(57) ABSTRACT

A method of making an alternative bottled water comprising as main ingredients, D-ribose, L-carnitine, Coenzyme Q10, Adenosine triphosphate, Taurine, Garcinia combgia, Chromium polynicotinate, or chromium picolate with or without L-Aspartic acid to provide cardiovascular fitness and overall physical energy. Said energy fitness water may also contain a non-nutritive or nutritive sweetener, aroma and coloring.

The bottled water prepared from these ingredients has pH range from 3.5 to 7.0 dependent on processing and packaging of the bottled water.

This invention relates to a bottled water that increases overall cardiovascular and physical energy and supress appetite to reduce weight by inhibiting fat production and keeping the taste as water.

### BACKGROUN OF THE INVENTION

Traditionally bottle water is plain or in some cases flavor is added to increase the palatability and drinkability of the water. Currently some bottled water are sold as spring water that contains flavors, vitamins, non-nutritive or nutritive sweeteners and processed at 195 F by lowering pH using fruit acids, such as citric, malic, or phosphoric acid. A taste test was conducted using experience sensory panel comparing spring water with flavor and sweetener verses plain bottled water. The plain bottled water was significantly preferred over spring water with fruit acids and sweetener. The panel made comments that spring water tasted like diet beverage and was not acceptable as bottled water. The use of fruit acids in bottled water causes strong sour taste that is usually eliminated by adding non-nutritive or nutritive sweetener with flavor.

### SUMMARY OF THE INVENTION

The present energy fitness water comprising energy ingredients, such as, D-Ribose, L-Carnitine, Co-enzyme Q10, Adenosine triphosphate, Taurine; fitness ingredients that is Garcinia combogia (Super CitriMax HCA), Chromium picolate, Chromium polynicotinate; minerals and vitamins such as Calcium, Magnesium, Potassium, Zinc, Pyridoxine Hydrochloride, (Vitamin B6), Cyanocobalamine (Vitamin B12), Folic Acid, Niacin, Calcium pantothenate, and stabilized with L-Aspartic acid to reduce the pH below 4.6 for hot fill or without L-Aspartic acid for aseptic processing while keeping the taste similar to plain bottled water. This energy fitness water may also contain non-nutritive sweeteners, masking flavor, fruit flavors, and food coloring. Water prepared from such energy fitness ingredients may have the pH 4.0-7.0 and processed at 195-210F. or aseptically. The advantage of energy fitness water is to increase cardiovascular fitness and overall physical energy, increased performance and endurance, to suppress appetite and inhibit fat production to help weight loss, and to provide essential minerals and vitamins to enhance the intake of bottled water with added value.

The energy ingredients, D-Ribose, L-Carnitine, Co-enzyme Q10, Adenosine triphosphate, Taurine, allows to offer an alternative water to consumer and offers added value to provide energy. The lack of carbonation and added minerals, vitamins, and amino acids, permit more rapid ingestion of water during periods of extreme thirst by the consumer. The inclusion of flavors without added calories would provide variety of taste without the concern of many calories to the end users.

This invention of energy fitness water that contains specified energy ingredient based on scientific studies as a single energy ingredient or combination of two or more ingredients depending upon the economics of the product. The specified energy ingredients are D-Ribose, L-Carnitine, Co-enzyme Q10, Adenosine triphosphate, and Taurine. The fitness ingredients contain, Garcinia combogia (Super CitriMax HCA), Chromium polynicotinate, or Chromium picolate. The minerals, vitamins, L-Aspartic acid, flavors, non-and nutritive sweeteners, are added to enhance the taste and nutritional value of water. The zero calories or few calories are highly beneficial to the consumers who wish to limit total calorie intake. The lack of carbonation should provide for rapid consumption of this product without the gassy/bloated feeling that usually occurs when copious amount of highly acidic carbonated beverages are rapidly consumed to alleviate thirst.

Essential Formulation Components are

Water: Reverse osmosis, de ionized chlorine free, filtered water is important for this water.

Energy Ingredients

D-Ribose: D-Ribose is a simple carbohydrate molecule found in every cell in the human body. D-Ribose is critical in the continuous production of ATP, the molecule which give our muscles and our heart the energy they need to perform. All muscles in the body rely on a constant supply of ATP for the energy they need to function properly. D-Ribose when taken as a nutritional supplement, bypasses the slow conversion steps to adenine nucleotides, and is readily available for inclusion in the recycling of ATP. Research indicates that those who have taken D-ribose, show that D-ribose provides: an overall increase physical energy levels; substantial increases in cardiovascular fitness and exercise; substantial reduction in recovery time following strenuous exercise or heavy labor; increased performance and endurance, and substantial reduction in post exercise stiffness and cramping.

L-Carnitine: Research indicates that L-carnitine enhances aerobic performance and allows the body to exercise longer without fatigue. Aids cardiac function by fueling the heart with energy, raises HDL levels, lowers triglycerides and reduces hypertension. It also assists in the burning of body fat.

Co Enzyme Q10 is a powerful antioxidant. It plays a critical role in the production of energy in every cell of the body. CO-Q10 aids in circulation, and stimulates the immune system.

Adenosine Triphosphate (ATP) is a stored energy that works by losing the endmost phosphate group when instructed to do so by an enzyme. This reaction releases a lot of energy, which the organism can then use to build proteins, contact muscles, etc. The reaction product is adenosine diphosphate (ADP), and the phosphate group either ends up as orthophosphate (HPO4) or attached to another molecule (e.g. an alcohol). Even more energy can be extracted by removing a second phosphate group to produce adenosine monophosphate (AMP).

Taurine: Taurine is an amino acid, component of bile acid, that are used in metabolism of fats and fat soluble vitamins for releasing energy. Taurine also regulates heartbeats, maintains cell membranes stability and helps prevent brain cell overactivity.

Fitness Ingridients

Garcinia combogia (Super CitriMax HCA): (−) Hydroxycitric Acid (HCA) is the active ingredient of Garcinia combogia that is the stabilized non-lactonized calcium and potassium salt of the free form of the acid and supplies 60% HCA by weight. Research indicates that HCA decreases synthesis of fats, including triglycerides and cholesterol; substantial increases in production of glycogen, decreases in appetite thus encourage weight loss, and are safe for consumption.

Chromium polynicotinate or Chromium picolate: Chromium polynicotinate (ChromeMate) and Chromium picolate are exceptionally bioactive source of the essential mineral chromium. Chromium plays a vital role in “sensitizing” the body's tissues to the hormone insulin. Research indicates that chromium helps to control appetite especially sugar cravings. It is believed that chromium sensitizes the “glucostat” in the brain that monitors blood sugar availability and tells you when you are hungry or not hungry. Chromium also helps to preserve muscle in dieters so that they burn more fat and less muscle. Clinical trials with 200 to 400 micrograms of chromium daily produced significant benefits.

L-Aspartic acid: An amino acid that is crystalline powder, odorless and has a slight acidic taste. This weak amino acid is used to lower the pH below 4.6 without altering the taste of bottled water.

Minerals: Organic or inorganic salts of Calcium, magnesium, zinc, and potassium salts premix provide essential minerals for healthy joints, muscles, nerve functioning and help regulate blood pressure.

Vitamins: Pyridoxine hydrochloride (Vitamin B6), Cyanocobalamine (Vitamin B12), Folic Acid, Niacin, vitamin C, and Calcium pantothenate are B-complex vitamins and are added to compensate the deficiencies of B-vitamins and also optimize the metabolic pathways where B-complex vitamins are used as co-enzymes.

Sweeteners: In some cases a non-nutritive or nutritive sweetener are added to improve the taste and to encourage the drinkability of the water without adding too many calories.

Flavors: Water soluble natural flavors would provide for thirst quenching appeal and variety to the consumer.

Preferred energy fitness water has a pH range from 3.5 to 7.0 depending upon the packaging and processing used for this water. A specially preferred composition for a ready made energy fitness water has the following composition:

### EXAMPLE 1

L-carnitine 500 mg/liter

Garcinia Cambogia (Super CitriMax (HCA)700 mg/liter

Chromium Polynicotinate (ChromeMate) 100 mcg/liter

Calcium 70 mg/liter

Potassium 100 mg/liter

Magnesium 12 mg/liter

Zinc 1.25 mg/liter

Selenium 15 mg/liter

Vitamin B6 0.7 mg/liter

Vitamin B12 2.12 mcg/liter

Folic Acid 140 mcg/liter

Niacin 2.75 mg/liter

Ca Pantothenate 1.5 mg/liter

Vitamin C 4.25 mg/liter

L-Aspartic acid 300 mg/liter

Natural aroma 150 mg/liter

The aforementioned formulation contains no sweetener. The pH of the drink is 4.2. The energy fitness water has a very pleasant taste. The purpose of energy fitness water is to provide ingredients that are known and scientifically studied to provide energy, fitness to lose weight, replenish fluids, vitamins, and electrolytes without altering the taste of bottled water.

Energy fitness water is typically ingested at short intervals during physical exertion. The test results show that the influence of pH is significant over the consumption of energy fitness water. The pH range from 4.4-7.0 is significantly more acceptable than the product tested at pH below 4.0. The panel indicated that energy fitness water below pH 4.0 tasted like non-carbonated soft drink when served with flavor and sweeteners.

### EXAMPLE 2

Garcinia combogia (Super CitriMax-HCA)700 mg/liter

Chromium Polynicotinate *ChromeMate) 100 mcg/liter

Calcium 70 mg/liter

Potassium 100 mg/liter

Magnesium 12 mg/liter

Zinc 1.25 mg/liter

Selenium 15 mg/liter

Vitamin B6 0.7 mg/liter

Vitamin B12 2.12 mcg/liter

Folic Acid 140 mcg/liter

Vitamin C 4.25 mg/liter

Sucralose 13.0 mg/liter

L-Aspartic acid 300 mg/liter

Natural aroma 150 mg/liter

The energy fitness water Example 2 had the pH 4.5, and contained only non-nutritive sweetener.

### EXAMPLE 3

Garcinia Cambogia (Super CitriMax-(HCA)700 mg/liter

Chromium Polynicotinate 100 mcg/liter

Calcium 70 mg/liter

Potassium 100 mg/liter

Magnesium 12 mg/liter

Zinc 1.25 mg/liter

Selenium 15 mg/liter

Vitamin B6 0.7 mg/liter

Vitamin B12 2.12 mcg/liter

Folic Acid 140 mcg/liter

Vitamin C 4.25 mg/liter

Natural aroma 150 mg/liter

The energy fitness water had the pH 5.8. The product example #3 when taste tested against bottled water score significantly better than bottled water.

### EXAMPLE #4

Garcinia Cambogia (Super CitriMax HCA)700 mg/liter

Chromium Polynicotinate (ChromeMate) 100 mcg/liter

Calcium 70 mg/liter

Potassium 100 mg/liter

Magnesium 12 mg/liter

Zinc 1.25 mg/liter

Selenium 15 mg/liter

Vitamin B6 0.7 mg/liter

Vitamin B12 2.12 mcg/liter

Folic Acid 140 mcg/liter

Niacin 2.75 mg/liter

Ca Pantothenate 1.5 mg/liter

Vitamin C 4.25 mg/liter

Sucralose 62 mg/liter

High Fructose Corn Syrup 1000 mg/liter

Acesulfame potassium 60 mg/liter

Citric Acid 1000 mg/liter

Natural aroma 150 mg/liter

Natural Berry Flavor 300 mg/liter

The energy fitness water has the pH 3.5 and score significantly lower than bottled water and product example #3. When fruit flavor was added and compared against non carbonated spring water with sugar and flavor, the product example #4 scored significantly higher.

What is claimed is:

1. The use of fitness ingredients such as Garcinia combogia (Super CitriMax HCA), chromium polynicotinate (ChromeMate) or chromium picolate in fitness bottled water that suppresses the appetite, reduces the production of fat metabolism and sensitizes the “glucostat” in the brain that monitors blood sugar availability. Provides overall physical fitness and replenishes body fluids and salts (Calcium & Potassium) lost due to vigorous physical exertion and stress.

2. The use of energy ingredients, such as L-carnitine, D-ribose, Co-enzyme Q10, Taurine, and adenosine triphosphate in bottled water as an individual energy ingredient or combination of two or more ingredients, when ingested that increases in physical energy level, substantial increases in cardiovascular fitness and exercise tolerance, substantial reduction in recovery time following strenuous exercise or heavy labor, and also increases exercise performance and endurance.

3. The use of L-Aspartic acid in beverages and bottled water that lowers the pH below 4.6 without altering the taste of beverages or bottled water for hot-fill processing.

4. The fitness water of claim 1 contains the following ingredients:
Garcinia cambogia (Super CitriMax (HCA) 700 mg/liter
Chromium Polynicotinate (ChromeMate) 100 mcg/liter
Calcium 70 mg/liter
Potassium 100 mg/liter
Magnesium 12 mg/liter
Zinc 1.25 mg/liter
Selenium 15 mg/liter
Vitamin B6 0.7 mg/liter
Vitamin B12 2.12 mcg/liter
Folic Acid 140 mcg/liter
Vitamin C 4.25 mg/liter
Natural aroma 150 mg/liter
The fitness water has a pH of 5.8 or it could be lowered to 4.4 using L-Aspartic acid for hot fill processing. The non-nutritive sweetener or nutritive sweetener could be used in combination with fruit flavors to make the fitness water more drinkable.
The energy fitness water of claim 2 contains number of energy ingredients that are used as an individual energy ingredient or used in combination with two or more ingredients. The energy ingredients are used with fitness ingredients, minerals, and vitamins with or without flavor at pH level from 3.5-5.8 with or without acids and flavor.
L-carnitine 250-500 mg/liter
D-ribose 250-500 mg/liter
Coenzyme Q10 10-25 mg/liter
Adenosine Triphosphate (ATP) 25-50 mg/liter
Taurine 250-1500 mg/liter
